(19) United States
(12) Patent Application Publication
(10) Pub. No.: US 2003/0156041 A1
(43) Pub. Date: Aug. 21, 2003

(54) Method of obtaining a reading of a utility meter

(76) Inventors: Gregory T. Taisto, Green Bay, WI (US); Steven J. Schneider, De Pere, WI (US); Sidney Mack Harrison, Rowlett, TX (US); David Lee Hill JR., Rockwall, TX (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/137,636

(22) Filed: May 2, 2002

Related U.S. Application Data
(63) Continuation of application No. 10/077,839, filed on Feb. 18, 2002.

(51) Int. Cl. G08C 15/06; G08B 23/00

(52) U.S. Cl. 340/870.02

(57) ABSTRACT

A method is provided of obtaining a reading of a utility meter. The method includes the steps of connecting a control circuit to the utility meter and transmitting a first data packet to the control circuit. The data packet requests the control circuit to read the utility meter. The utility meter is read in order to obtain a meter reading and a second data packet is constructed from the meter reading. The second data packet is transmitted to a central server which generates a utility bill in response to the second data packet.

### RELATED APPLICATION DATA

This application is a continuation of Ser. No. 10/077,839, filed Feb. 18, 2002 and entitled METHOD OF TRANSMITTING DATA.

### FIELD OF THE INVENTION

This invention relates generally to the transmission of data, and in particular, to a method of obtaining a reading of a utility meter from a remote location.

### BACKGROUND AND SUMMARY OF THE INVENTION

The acquisition and transmission of information and data have become significant priorities for all types of businesses. The gathering of the information and the transmission of the information to the proper destination is both time consuming and expensive. By way of example, businesses such as local utility companies must obtain readings of the utility meters of each individual customer. This is often a time consuming task wherein individual meter readers go to each individual customer's home in order to read that customer's utility meter. Thereafter, the information gathered by the meter readers must be transmitted to the billing department of the local utility company in order for the billing department to generate bills for each customer. It can be appreciated that this process adds significantly to the overall cost of the utilities for the customers. A simple and more efficient method for gathering information and transmitting the same to its intended destination is highly desirable.

In addition, it has also become highly desirable to transmit large volumes of information and data over various communication networks. By way of example, the transmission of sound and video over the internet has become commonplace. The transmission of such information requires large packets of data to travel over a communication network such as the internet which, in turn, requires a significant amount of bandwidth. The cost of such bandwidth can be quite substantial. Further, it can be appreciated that many transactions require the transmission of only a small amount of data. For example, credit card terminals are often used by retailers to obtain the approval of sales transactions. The credit card terminal transmits the account information from the credit card and the amount of the items to be purchased over a communication network such as a telephone line to a central computer. Based upon the account information and the amount of the proposed purchase, the central computer determines whether to approve the purchase and transmits that decision to the credit card terminal over the telephone line. This process is repeated for each sales transaction that occurs at a retailer. Since credit card terminals are provided for each individual cash register at a particular retailer and each credit card terminal must include its own individual phone line to connect the credit card terminal to the central computer, a portion of the costs for the telephone line and equipment must be passed on by the retailer to the customer on each sales transaction. Therefore, it is highly desirable to provide a more economical method for repeatedly transmitting small packets of data.

Therefore, it is a primary object and feature of the present invention to provide a method of obtaining a reading of a utility meter from a remote location.

It is a further object and feature of the present invention to provide a method of obtaining a reading of a utility meter from a remote location that is simple and inexpensive.

It is a still further object and feature of the present invention to provide a method of obtaining a reading of a utility meter from a remote location that reduces the number of man-hours associated with performing prior methods.

In accordance with the present invention, a method is provided of obtaining a reading of a utility meter. The method includes the steps of connecting a control circuit to the utility meter and transmitting a first data packet to the control circuit. The data packet requests the control circuit to read the utility meter. The utility meter is read in order to obtain a meter reading and a second data packet is constructed from the meter reading.

The second data packet is transmitted to a server and a utility bill is generated in response to the second data packet. The control circuit is interconnected to a telephonic network and the first data packet is transmitted to the control circuit over that telephonic network. The telephonic network is selected from the group consisting of wire line, wireless data service, internet layers using an internet protocol, wireless terminal forward control channel, and wireless terminal reverse control channel.

A telephony device is connected to the control circuit and to the telephonic network. In addition, a peripheral device may be connected to the telephony device. The peripheral device has the ability to transmit and receive data over the telephonic network using the telephony device. The control circuit controls the receipt and transmission of the data by the peripheral device over the telephonic network using the telephony device. The peripheral device is selected from the group consisting of a conventional telephone; a wireless, broadband device; a second utility meter; a cordless telephone; a security system; an electrical control panel interface; industrial equipment; or a billing system interface.

In accordance with a further aspect of the present invention, a method is provided for obtaining a reading of a utility meter. The method includes the steps of generating a first data packet for a selected utility meter and operatively connecting a control circuit to the selected utility meter. The first data packet requests a reading of the selected utility meter. The first data packet is transmitted to the control circuit over a first telephonic network. The selected utility meter is read in order to obtain a meter reading in response to receipt of the first data packet of the control circuit. A second data packet is constructed from the meter reading and is transmitted to a server over a second telephonic network. A utility bill is generated in response to the second data packet.

The first telephonic network may be the same as the second telephonic network. Alternatively, the first and second telephonic networks may be selected from the group consisted of wire line, wireless data service, internet layers using an internet protocol, wireless terminal forward control channel, and wireless terminal reverse control channel.

A telephony device may be operatively connected to the control circuit and to the first and second telephonic networks. A peripheral device may be connected to the telephony device. The peripheral device has the ability to transmit and receive data on the first and second telephonic networks using the telephony device. The control circuit controls the receipt and transmission of the data by the peripheral device. The peripheral device is selected from the group consisting of a conventional telephone; a wireless, broad band device; a second utility meter; a cordless telephone; a security system; an electrical control panel interface; industrial equipment; or a billing system interface. It is contemplated to allow user access to the server over a network such that the user may review the utility bill. It is contemplated that the network be the internet.

In accordance with a further aspect of the present invention, a method is provided for obtaining a meter reading. The method includes the steps of connecting a control circuit to the utility meter and transmitting a request to the control circuit to read the utility meter. The utility meter is read to obtain a meter reading and the meter reading is transmitted to a desired location over a communications network.

A utility bill may be generated in response to the meter reading. The control network is selected from the group consisting of wire line, wireless data service, internet layers using the internet protocol, wireless terminal forward control channel and wireless terminal reverse control channel.

A telephony device is connected to a control circuit and to the communications network. A peripheral device is connected to the telephony device. The peripheral device has the ability to transmit and receive data over the communications network using the telephony device. The control circuit controls the receipt and transmission of the data by the peripheral device over the communications network. The peripheral device is selected from the group consisting of a conventional telephone; a wireless broad band device; a second utility meter; a cordless telephone; a security system; an electrical control panel interface; industrial equipment; or a billing system interface.

It is contemplated to allow user access to the desired location over a second network such that the user may review the utility bill. The second network may be the internet.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a schematic view of a system for transmitting data in accordance with the method of the present invention;

FIGS. 2A and 2B are flow charts of the method of the data transmission in accordance with the present invention;

FIG. 3 is a flow chart of a method of selecting a data path in accordance with the present invention;

FIG. 4 is a flow chart of a method of building a packet of data in accordance with the method of the present invention;

FIG. 5 is a flow chart of a method of establishing a connection in accordance with the present invention;

FIG. 6 is a flow chart of the method for transmitting data in accordance with the present invention;

FIG. 7 is a flow chart of a method for receiving data in accordance with the method of the present invention;

FIG. 8 is a flow chart of a method of transmitting data utilizing caller identification and in accordance with the method of the present invention;

FIG. 9 is a flow chart of a method for receiving data using caller identification in accordance with the method of the present invention;

FIG. 10 is a flow chart of a method for transmitting data using short message service in accordance with the method of the present invention;

FIG. 11 is a flow chart of a method of receiving data using short message service in accordance with the present invention;

FIG. 12 is a flow chart of a method for transmitting of data using the control channel in accordance with the present invention; and

FIG. 13 is a flow chart of a method for receiving data using a control channel in accordance with the present invention.

### DETAILED DESCRIPTION OF THE DRAWINGS

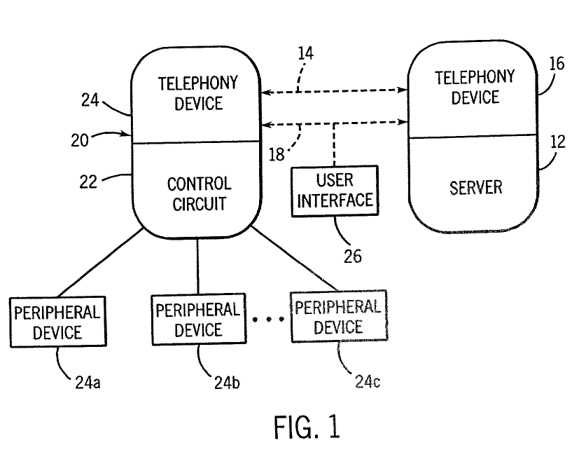

Referring to FIG. 1, a system for effectuating the method of the present invention is generally designated by the reference numeral 10. System 10 includes stationary, computer server 12 operatively connected to a telephonic network 14 by a telephony device 16. It is contemplated that network 14 be a wireless network, but a wire line network may be used without deviating from the scope of the present invention. It is also contemplated to operatively connect server 12 to a secondary network 18 such as the internet through telephony device 16. A user access terminal 26 may be operatively connected to the internet 18 so as to allow a user to communicate with server 12, for reasons hereinafter described. It is intended that server 12 execute a computer software program in a conventional manner so as to allow server 12 to send and receive packets of data, as well as, to generate packets of data, as hereinafter described.

System 10 further includes a terminal device generally designated by the reference numeral 20. Terminal device 20 includes a control circuit 22 operatively connected to wireless network 14 through telephony device 24. Control circuit 22 may also be interconnected to secondary network 18 through telephony device 24. Control circuit 22 runs a computer software program, as hereinafter described, to execute a portion of the method of the present invention. Control circuit 22 generates and receives packets of data that may be transmitted to server 12 over wireless network 14 and/or secondary network 18 by telephony device 24. Various peripheral devices 24a-24c may be operatively connected to control circuit 22 that, in turn, connects peripherals devices 24a-24c to telephony device 24 of terminal device 20. It is contemplated for control circuit 22 to selectively connect peripheral devices 24a-24c to wireless network 14 and/or secondary network 18, for reasons hereinafter described. Alternatively, control circuit 22 may obtain information from peripheral devices 24a-24c and generate packets of data which may be transmitted to server 12 over wireless network 14 and/or internet 18 by telephony device 24. By way of example, peripheral devices 24a-24c may take the form of:

1) Conventional telephone;

2) Wireless, broadband device;

3) Utility meter;

4) Cordless telephone;

5) Security system;

6) Control panel or electrical interface;

7) Industrial equipment; or

8) Billing system interface for enabling or disabling usage.

It can be appreciated that the preceding list of peripheral devices is merely exemplary, and that other types of peripheral devices may be connected to control circuit 22 without deviating from the scope of the present invention.

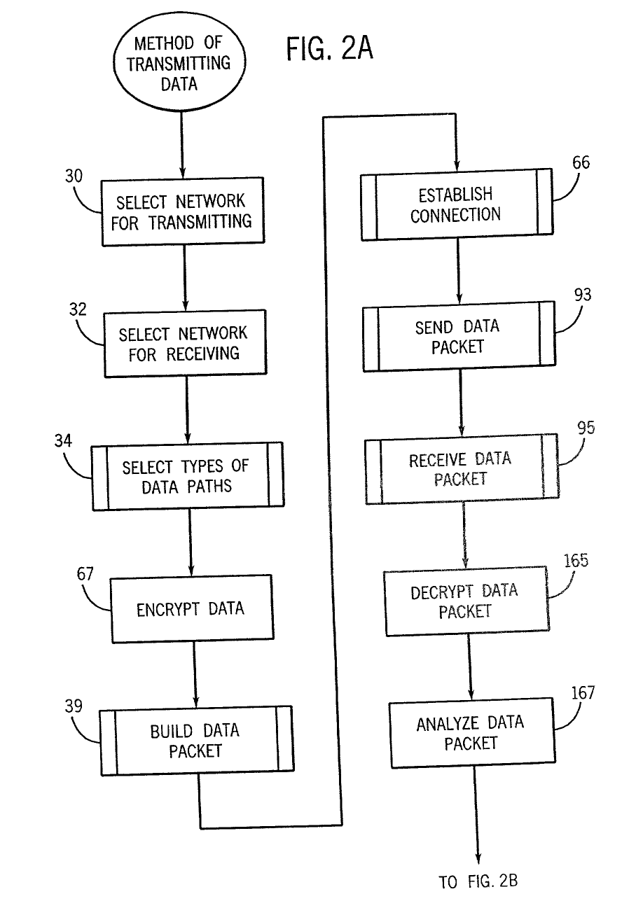

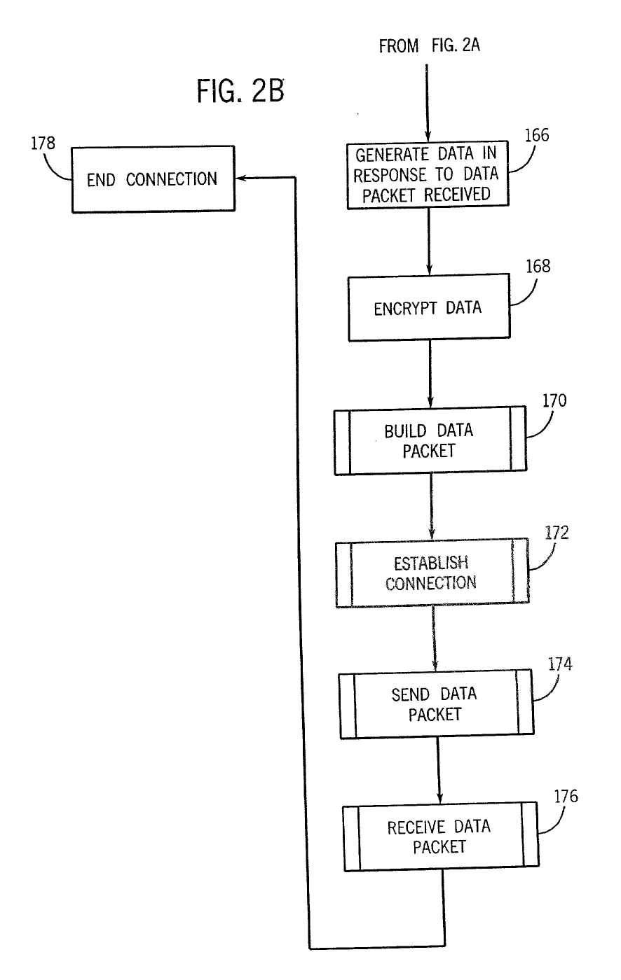

In order to facilitate an understand of the method of the present invention, it is contemplated to designate server 12 as a transmitting device and to designate terminal device 20 as a receiving device. However, it can be understood that terminal device 20 may act as the transmitting device and server 12 may act as the receiving device without deviating from the scope of the present invention. Referring to FIGS. 2A and 2B, by way of example, it is often times desirous for server/transmitting device 12 to obtain various types of data from terminal device/receiving device 20. As such, server/transmitting device 12 must periodically request data and information from terminal device/receiving device 20. Initially, server/transmitting device 12 selects a network, either wireless network 14 or the secondary network 18, upon which a control data packet will be transmitted by server/transmitting device 12 to terminal device/receiving device 20, block 30, and selects a network, either wireless network 14 or secondary network 18, upon which server/transmitting device 12 will receive an information data packet from terminal device/receiving device 20, block 32. In addition, server/transmitting device 12 selects the type of data path with which server/transmitting device 12 transmits packets of data, and the type of data path with which terminal device/receiving device 20 transmits packets of data, block 34. The types of data paths that may be selected include, but are not limited to, the following:

1) Conventional wire-line using various modem protocols;

2) Wireless data services such as:

a) Industry Standard Data Services #707;

b) Short Message Service;

c) Caller Identification;

d) Wide Band Code Division Multiple Access Technology;

e) CDMA2000;

f) cdmaOne;

g) General Pocket Radio Service;

h) Enhanced Data Rates for Global Evolution;

i) Dual Tone Multiple Frequency;

j) Manual Interaction with Interactive Voice Response Systems;

k) Infrared Driver Layers; and

l) Frequency Modulation;

3) Internet Layers using Various Internet Protocols;

4) Wireless Terminal Forward Control Channels; and

5) Wireless Terminal Reverse Control Channels.

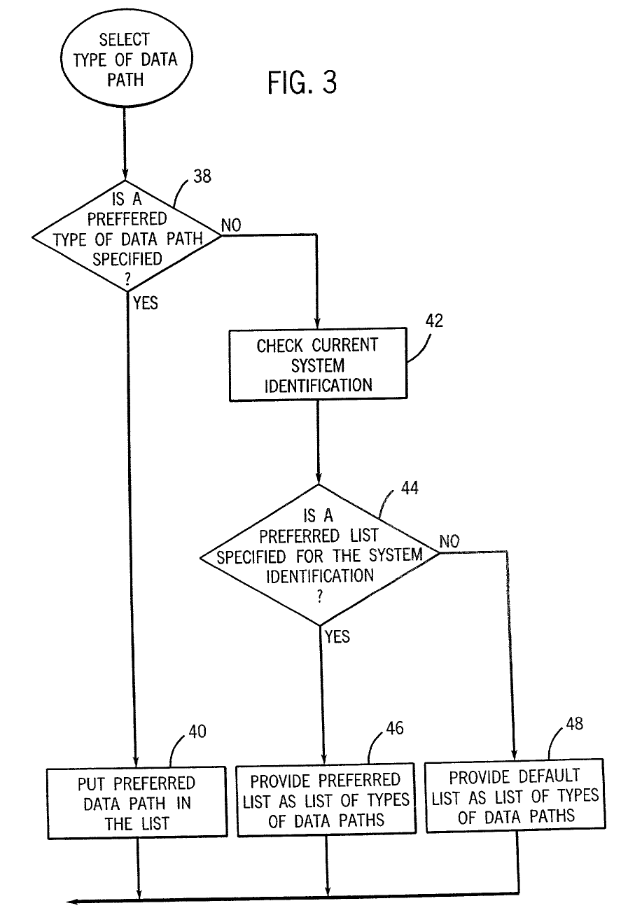

Referring to FIG. 3, a method is provided for selecting the type of data paths which server/transmitting device 12 and terminal/receiving device 20 utilize to transmit packets of data. Initially, it is determined whether a preferred type of data path has been specified by a user, block 38. If the type of data path has been specified by a user, the specified type of data path is placed on a list of types of data paths, block 40, for future reference. If the type of data path has not specified by the user, the server/transmitting device 12 checks the current system identification for wireless network 14, block 42, and determines if the preferred list of types of data paths is specified for the current system identification, block 44. If the preferred list of types of data paths is specified for the current system identification, the preferred list of types of data paths is provided as the list of types of data paths, block 46, for future reference. Alternatively, if no preferred list of data paths is specified for the current system identification, a default preferred list of types of data paths is provided as the list of types of data paths, block 48, for future reference.

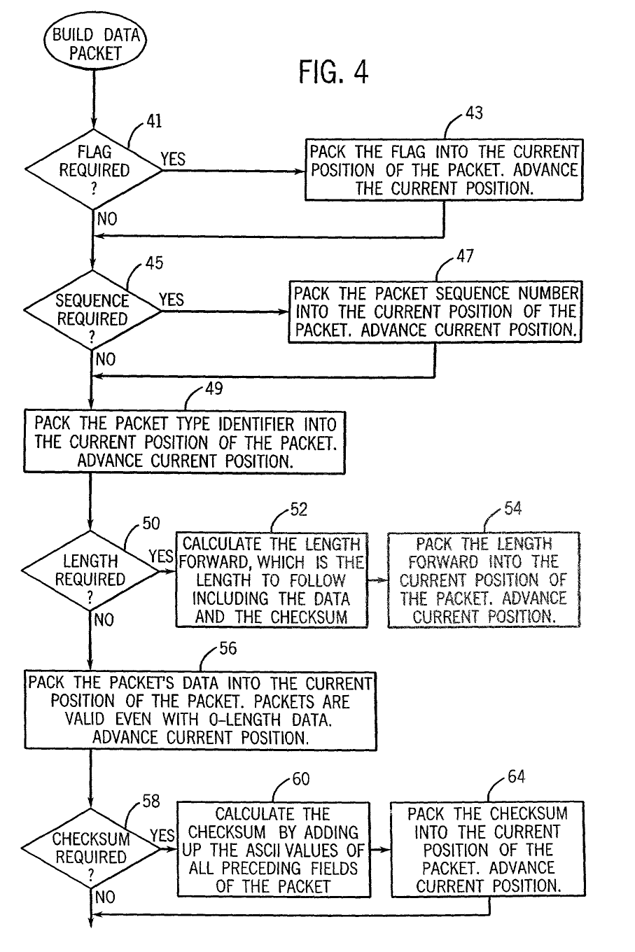

Once the networks 14 or 18 upon which the data packets will be transmitted and the lists of types of data paths have been determined, FIG. 3, the server/transmitting device 12 builds a data packet in accordance with the first type of data path identified on the list of types of data paths, block 39, as heretofore described, FIGS. 2A and 2B. Referring to FIG. 4, a data packet is constructed from a variable set of six parameters and has a plurality of bytes reserved for each parameter. These parameters include: a flag to identify a data packet as a packet of data for use in accordance with the method of the present invention; a sequence identifier in the event that multiple data packets will be transmitted by the server/transmitting device 12; a packet-type parameter to identify the packet as a control data packet or an information data packet, hereinafter described; the length of the data provided in the data packet; the data in the data packet; and a checksum parameter to provide the summed ASCII values of all proceeding fields of the data packet. The actual parameters used and the number of bytes reserved for each parameter are determined by the particular type of data path being used to transmit the data.

In order to build a data packet, it is first determined whether a flag is required, block 41. If a flag is not required, no flag is provided. Alternatively, if a flag is required, a flag is provided at the first byte position of the data packet and the byte position is advanced, block 43. It is next determined if a sequence number is required, block 45. If no sequence number is required, none is provided. If a sequence number is required, the sequence number is packed into the current byte position of the data packet and the byte position of the data packet is advanced, block 47. Thereafter, packet-type identifier is packed into the next byte position of the data packet in order to specify whether the data packet is a control data packet or an information data packet, block 49. If the length of the data within the data packet is required, block 50, the length of the data within the data packet is calculated, block 52, and packed into the current byte position of the data packet, block 54. Thereafter, the byte position of the data packet is advanced. Alternatively, if the length of the data packet is not required, none is provided. The data is packed into the current byte position of the data packet and the byte position of the data packet is advanced, block 56. It is contemplated that a data packet may be valid even if the data for the data packet has a length of zero. Finally, it is determined whether a checksum parameter is required, block 58. If no checksum parameter is required, none is provided. If a checksum parameter is required, the checksum parameter is calculated by adding the ASCII values of all proceeding parameters of the data packet, block 60. Thereafter, the value of the checksum parameter is packed into the current byte position of the data packet and the byte position of the data packet is advanced, block 64.

Referring back to FIGS. 2A and 2B, it is contemplated for server/transmitting device 12 to construct a control data packet, in accordance with the prior description, that provides instructions to technical device/receiving device 20. Such instructions are provided in the control data packet as the data. It is intended that the data to be provided in the control data packet be encrypted, block 67, in any conventional manner prior to packing the data into the control data packet, block 56 of FIG. 4.

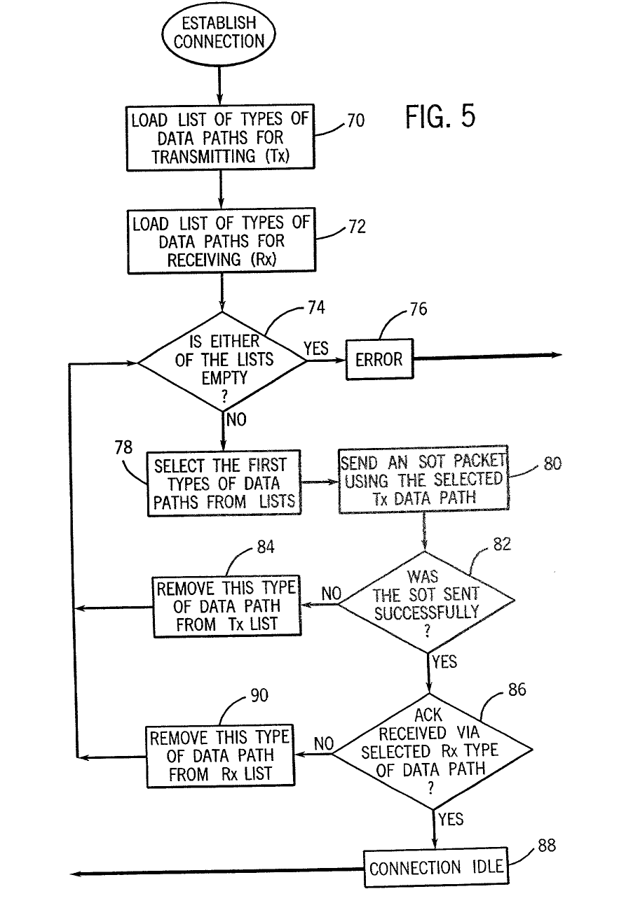

Once the control data packet has been built, block 39, a connection must be established between server/transmitting device 12 and terminal device/receiving device 20, via the selected transmission network, block 66. Referring to FIG. 5, in order to establish a connection, the list of types of data paths for transmitting the data packet by server/transmitting device 12 and the list of types of data paths for receiving a data packet from terminal device/receiving device 20, blocks 70 and 72, respectively, are reviewed. If either of the lists of types of data packets is empty, block 74, an error occurs, block 76, and the transfer of the control data packet is terminated. If the lists of types of data paths are not empty, then the first types of data paths identified on each of the lists of types of data paths are selected, block 78.

In order to insure the proper transmission of the data packets over network 14, it is contemplated for server/transmitting device 12 to send a start of transmission data packet to terminal device/receiving device 20 and for terminal device/receiving device 20 to send an acknowledgement back to server/transmitting device 12. By way of example, the start of transmission data packet is sent on the selected network 14 utilizing the selected type of data path, block 80. Thereafter, it is determined whether the start of transmission data packet was successfully sent, block 82. If the start of transmission data packet was not successfully sent, the selected type of data path is removed from the list of types of data paths, block 84, and the start of transmission data packet is retransmitted by the server/transmitting device 12 utilizing the second type of data path identified on the list of types of data paths. If the start of transmission data packet was successfully sent by the server/transmitting device 12, block 82, the server/transmitting device 12 awaits acknowledgement from terminal device/receiving device 20, block 86. If an acknowledgement is received by the server/transmitting device 12, a connection between the server/transmitting device 12 and the terminal device/receiving device 20 is established and remains idle awaiting the further transmission of data thereon, block 88. Alternatively, if an acknowledgement is not received by the server/transmitting device 12, the selected type of data path is removed from the list of types of data paths for receiving the data packet, block 90, and the process for establishing a connection is repeated.

Referring to back to FIGS. 2A and 2B, once a connection is established, as heretofore described, the control data packet is transmitted by the server/transmitting device 12 on the network 14 via the selected type of data path, block 93, such that the control data packet is received by terminal device/receiving device 20, block 95. Depending on the selected type of data paths, the procedure for sending and receiving the data packet, blocks 93 and 95, respectively, varies.

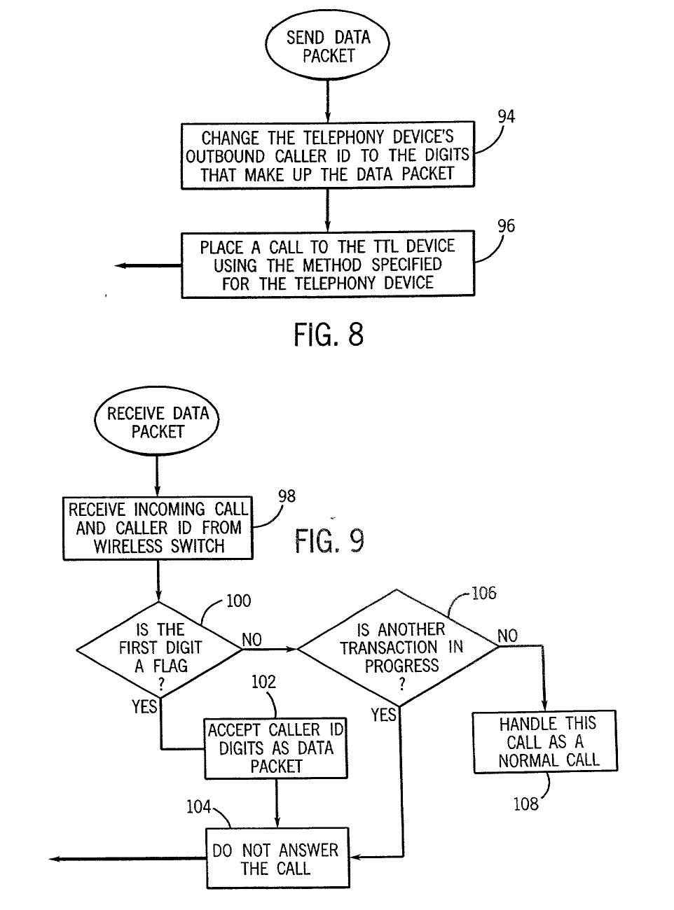

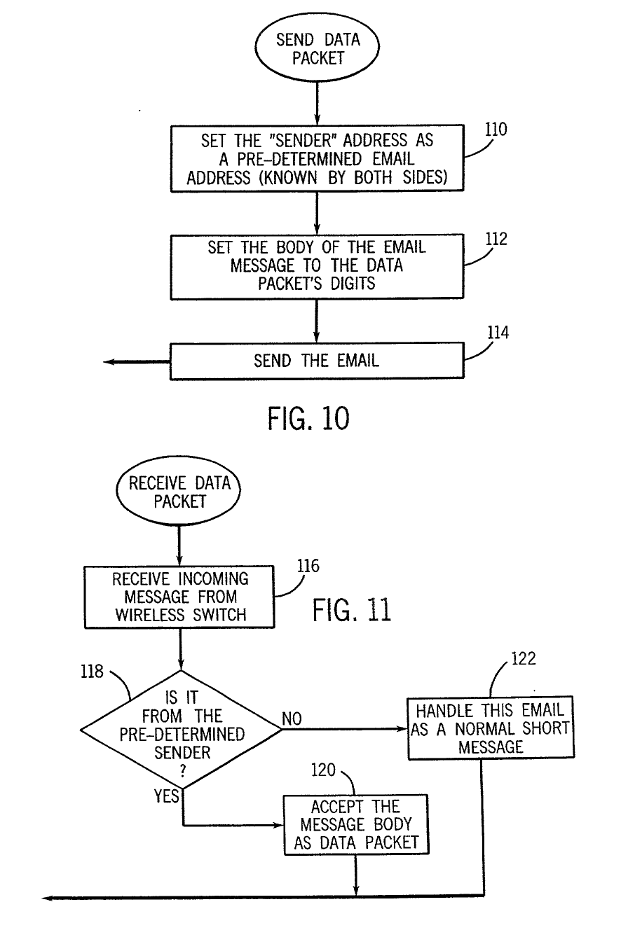

Referring to FIGS. 8-9, if the server/transmitting device 12 decides to send the control data packet using a wireless data services such as caller identification, the outbound caller identification information for telephony device 16 is replaced with the control data packet prior to transmission of the control data packet, block 94. Telephony device 16 then places a telephone call on network 14 to terminal device/receiving device 20 so as to provide the control data packet to terminal/receiving device 20, block 96. Referring to FIG. 10, telephony device 24 of terminal device/receiving device 20 receives the incoming telephony call and the control data packet (transmitted as caller identification information) sent by server/transmitting device 12, block 98. Thereafter, it is determined if the first digit of control data packet is a predetermined flag, block 100. If the first digit of the controlled data packet corresponds to the predetermined flag, control circuit 22 of terminal device/receiving device 20 accepts the caller identification information as a control data packet, block 102, for further analysis. It is unnecessary for telephony device 24 of terminal device/receiving device 20 to answer the telephone call. Alternatively, it is determined whether another data packet transmission is in progress, block 106. If another data packet transmission is in progress, telephony device 24 of terminal device/receiving device 20 does not accept the control data packet, block 104. In addition, if the first digit of the control data packet is not a flag and if another data transmission is not in progress, control circuit 22 of terminal device/receiving device 20 recognizes the incoming telephone call as not originating from server/transmitting device 12. As such, control circuit 22 of terminal device/receiving device 20 allows the telephone call to proceed to one of the peripheral devices 24a-24c attached thereto. By way of example, peripheral devices 24a-24c may take the form of conventional telephones so as to allow a user to utilize the peripheral devices 24a-24c to receive the incoming telephone call in a conventional manner, block 108.

Referring to FIGS. 10-11, it is contemplated to transmit the control data packet utilizing a wireless data services such as short message service. In order to use short message service, a third party e-mail software such as that provided by Unex or Microsoft is utilized. Server/transmitting device 12 utilizes the e-mail software to send an e-mail message to terminal device/receiving device 20. The “sender's” e-mail address in such e-mail message is replaced with a predetermined e-mail address known by both server/transmitting device 12 and by terminal device/receiving device 20, block 110. The body of the e-mail message contains the control data packet, block 112. Telephony device 16 sends the e-mail message containing the control data packet on network 14 to terminal device/receiving device 20, block 114. Telephony device 24 of terminal device/receiving device 20 receives the e-mail message sent by telephony device 16, block 116, and control circuit 22 determines if the sender's e-mail address corresponds to the predetermined e-mail address, block 118. If the sender's e-mail address corresponds to the predetermined e-mail address, control circuit 22 accepts the body of the e-mail message as a control data packet, block 120. If the sender's e-mail address does not correspond to the predetermined e-mail address, control circuit 22 handles the e-mail message in a conventional manner, block 122. As is conventional, telephony device 24 of terminal device/receiving device 20 may display the e-mail message, or such e-mail message may be provided to one or more of the peripheral devices 24a-24c attached to control circuit 22.

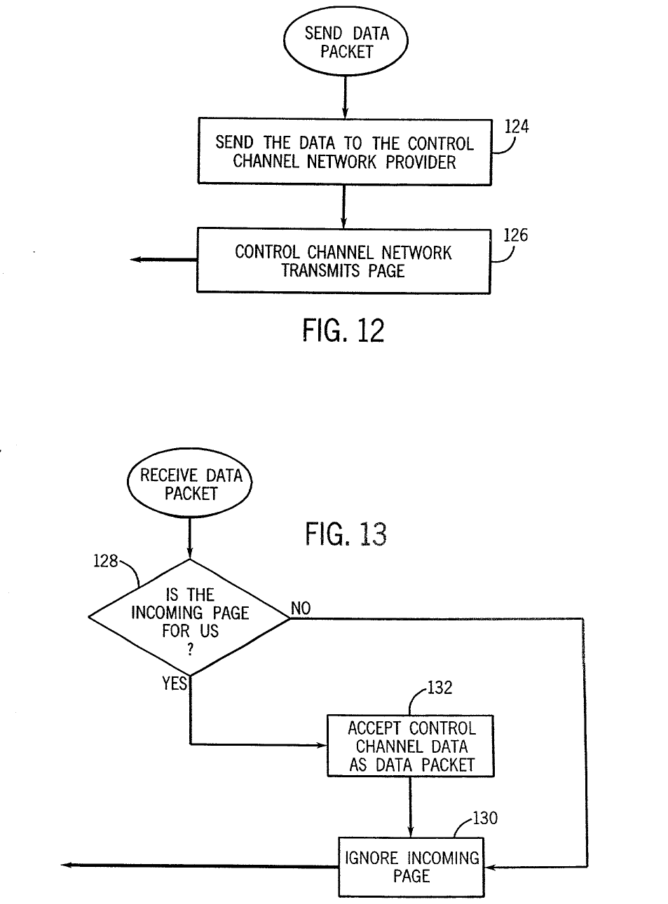

Referring to FIGS. 12-13, it is contemplated to send the control data packet using a control channel data path such as wireless terminal forward control channels or wireless terminal reverse control channels. The control channel data path requires an internet connection whereby server/transmitting device 12 transmits the control data packet to a control channel network, block 124. The control channel network transmits the control packet to terminal device/receiving device 20 as a page, block 126. Thereafter, telephony device 24 of terminal device/receiving device 20 receives the page and determines whether the page corresponds to a control data packet from server 12, block 128. If control circuit 22 of terminal device/receiving device 20 determines that the incoming page is not a control data packet, control circuit 22 ignores the incoming page, block 130. If control circuit 22 recognizes the incoming page as a control data packet, control circuit 22 accepts the control channel data as a control data packet, block 132. Thereafter, control circuit 22 ignores the incoming page.

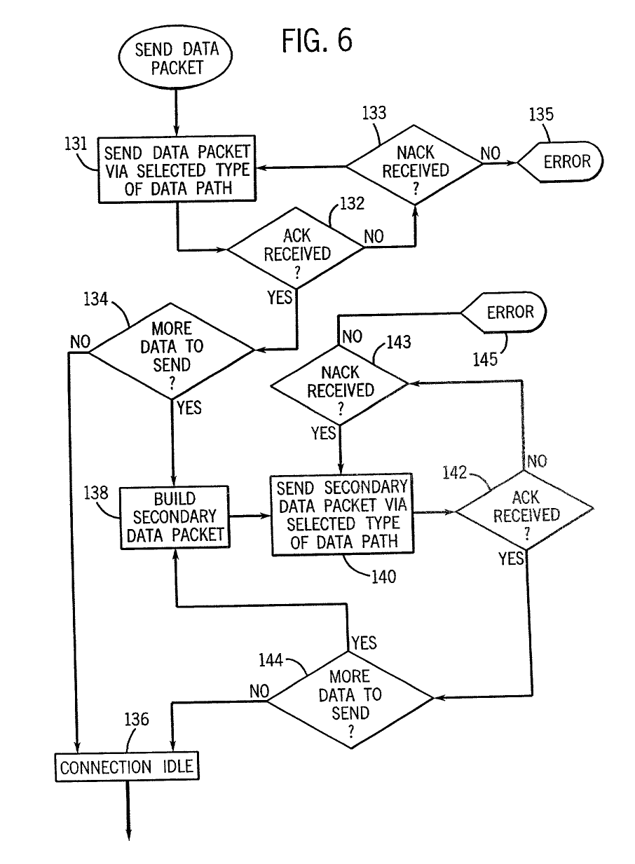

Referring back to FIG. 6, the control data packet may be transmitted by server/transmitting device 12 as conventional data over network 14, block 131. As such, after transmission of control data packet, server/transmitting device 12 awaits an acknowledgement of receipt of the control data packet by terminal device/receiving device 20, block 132. If server/transmitting device 12 receives a data packet from terminal device/receiving device 20 indicating that the control data packet is improper, Nack, block 133, (e.g. the checksum parameter is incorrect) server/transmitting device 12 resends the control data packet, block 92. If no acknowledgement is received by server/transmitting device 12, an error has occurred and the transmission is terminated, block 135. If server/transmitting device 12 receives an acknowledgement from terminal device/receiving device 20, server/receiving device 12 determines whether additional data must be sent, block 134. If no additional data needs to be sent, the connection between server/transmitting device 12 and terminal device/receiving device 20 goes idle, block 136. If additional data needs to be sent, an additional data packet is constructed, as heretofore described, block 138, and the newly constructed data packet is sent by the server/transmitting device to the terminal device/receiving device 140 over network 14 via the selected type of data path, block 140. Once again, server/transmitting device 12 awaits an acknowledgement of receipt of the newly constructed data packet by the terminal device/receiving device 20, block 142. If server/transmitting device 12 receives information from terminal device/receiving device 20 that the newly constructed data packet is improper, block 143, server/transmitting device 12 resends the newly constructed data packet to terminal device/receiving device 20, as heretofore described, block 140. If server/transmitting device 12 does not receive an acknowledgement, an error occurs and the transmission of the newly constructed data packet is terminated, block 145. If server/transmitting device 12 receives an acknowledgement, it is determined whether additional data needs to be sent, block 144. If additional data needs to be sent, an additional data packet is constructed, block 138, and the process is repeated. If no additional data needs to be sent, the connection idles, block 136.

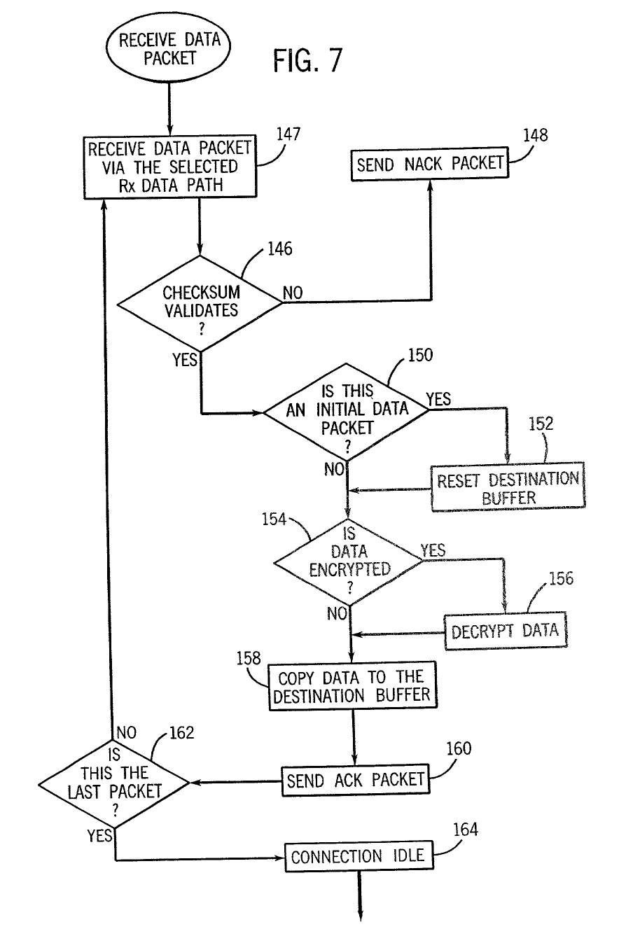

Referring to FIG. 7, upon receipt of the control data packet, terminal device/receiving device 20 analyzes the control data packet to determine whether the checksum parameter for the control data packet is valid, block 146. If the checksum parameter is not valid, terminal device/receiving device 20 sends a data packet to server/transmitting device specifying that the data packet received from server/receiving device is improper, block 148. If the checksum parameter of the control data packet is valid, terminal device/receiving device 20 determines if the control data packet received is an initial data packet, block 150. If it is an initial data packet, the designation buffer of control circuit 22 is reset, block 152. Thereafter, terminal device/receiving device 20 determines whether the data contained within the control data packet is encrypted, block 154. If the data of the control data packet is encrypted, it is decrypted in any conventional manner, block 156. The decrypted data is copied to the designation buffer of control circuit 22 of terminal device/receiving device 20, block 158. An acknowledgement of a properly received data packet is sent by terminal device/receiving device 20 to server/transmitting device 12, block 160, and the terminal device/receiving device 20 determines whether this is the last data packet to be received, block 162. If additional data packets are to be received, the terminal device/receiving device 20 continues to await the additional data packets, block 147. If the data packet received by the terminal device/receiving device 20 is the last data packet to be received, the connection between server/transmitting device 12 and terminal device/receiving device 20 goes idle, block 164.

Referring back to FIGS. 2A and 2B, the control data packet received from server/transmitting device 12 is decrypted, block 165, and analyzed, block 167, by control circuit 22 of terminal device/receiving device 20. In response thereto, control circuit 22 of terminal device/receiving device 20 generates data, block 166, for transmission back to server/transmitting device 12. It can be appreciated that the information data packet is built in the same manner as heretofore described with respect to the control data packet built by server/transmitting device 12. As such, the previously description of building a data packet is understood to describe the building of an information data packet, as if fully described herein.

By way of example, based upon the instructions received from server/transmitting devices 12 in the control data packet, control circuit 22 of terminal device/receiving device 20 may gather information from one of the peripheral devices 24a-24c. The data for the information data packet to be transmitted by terminal device/receiving device 20 to server/transmitting device 12 is encrypted if so desired, block 168, and an information data packet is generated by control circuit 22 of terminal device/receiving device 20, block 170. Telephony device 24 of terminal device/receiving device 20 establishes a connection with telephony device 16, and hence server 12, over the previously selected network 14 or 18, as heretofore described, block 172, and the information data packet is sent by terminal/receiving device 20 to server/transmitting device 12 over, by way of example, network 14 using the selected type of data path, block 174, as heretofore described. Server/transmitting device 20 receives the information data packet, 176, as heretofore described, and the connection between terminal device/receiving device 20 and server/transmitting device 12 is terminated, block 178.

It can be appreciated that methodology of the present invention allows for the simple transmission of data between server/transmitting device 12 and terminal device/receiving device 20. By way of example, server/transmitting device 12 may send a control data packet to terminal device/receiving device 20 requesting a reading of a customer's gas meter. One of the peripheral devices 24a-24c may take the form of a customer's gas meter which is operatively connected to control circuit 22 of terminal device/receiving device 20. Upon receipt of the control data packet from server/transmitting device 12 requesting the reading of the gas meter, control circuit 22 may read such gas meter attached thereto. Thereafter, an information data packet may be constructed containing the data from the reading of the customer's gas meter and such information data packet may be transmitted from terminal device/receiving device 20 to server/transmitting device 12, as heretofore described. It can be appreciated, by interconnecting server/transmitting device 12 to secondary network 18, such as the internet, a local gas company and/or a customer may access the customer's records. This, in turn, will simplify billing procedures and billing questions.

Various modes of carrying out the invention are contemplated as being within the scope of the following claims particularly pointing out and distinctly claiming the subject matter which is regarded as the invention.

We claim:

1. A method of obtaining a reading of a utility meter, comprising the steps:
connecting a control circuit to the utility meter;
transmitting a first data packet to the control circuit, the data packet requesting the control circuit read the utility meter;
reading the utility meter to obtain a meter reading; and
constructing a second data packet from the meter reading.

2. The method of claim 2 comprising the additional step of:
transmitting the second data packet to a server.

3. The method of claim 1 comprising the additional step:
generating a utility bill in response to the second data packet.

4. The method of claim 1 comprising the additional step of interconnecting the control circuit to a telephonic network and wherein the first data packet is transmitted to the control circuit over the telephonic network.

5. The method of claim 4 wherein telephonic network is selected form the group consisting of: wire-line, wireless data service, internet layers using an internet protocol, wireless terminal forward control channel, and wireless terminal reverse control channel.

6. The method of claim 1 comprising the additional steps of:
connecting a telephony device to the control circuit;
connecting the telephony device to the telephonic network; and
connecting a peripheral device to the telephony device.

7. The method of claim 6 wherein the peripheral device has the ability to transmit and receive data over the telephonic network using the telephony device and wherein the control circuit controls receipt and transmission of the data by the peripheral device over the telephonic network using the telephony device.

8. The method of claim 6 wherein the peripheral device is selected from the group consisting of: a conventional telephone; a wireless, broadband device; a second utility meter; a cordless telephone; a security system; an electrical control panel interface; industrial equipment; or a billing system interface.

9. A method of obtaining a reading of a utility meter, comprising the steps:
generating a first data packet for a selected utility meter, the first data packet requesting a reading of the selected utility meter;
operatively connecting a control circuit to the selected utility meter;
transmitting the first data packet to the control circuit over a first telephonic network;
reading the selected utility meter to obtain a meter reading in response to receipt of the first data packet by the control circuit;
constructing a second data packet from the meter reading; and
transmitting the second data packet to a server over a second telephonic network; and
generating a utility bill in response to the second data packet.

10. The method of claim 9 wherein the first telephonic network is the same as the second telephonic network.

11. The method of claim 9 wherein first telephonic network is selected form the group consisting of: wire-line, wireless data service, internet layers using an internet protocol, wireless terminal forward control channel, and wireless terminal reverse control channel.

12. The method of claim 9 wherein second telephonic network is selected form the group consisting of: wire-line, wireless data service, internet layers using an internet protocol, wireless terminal forward control channel, and wireless terminal reverse control channel.

13. The method of claim 9 comprising the additional steps of:
operatively connecting a telephony device to the control circuit;
operatively connecting the telephony device to the first and second telephonic networks; and
operatively connecting a peripheral device to the telephony device.

14. The method of claim 13 wherein the peripheral device has the ability to transmit and receive data over the first and second telephonic networks using the telephony device and wherein the control circuit controls receipt and transmission of the data by the peripheral device over the first and second telephonic networks using the telephony device.

15. The method of claim 13 wherein the peripheral device is selected from the group consisting of: a conventional telephone; a wireless, broadband device; a second utility meter; a cordless telephone; a security system; an electrical control panel interface; industrial equipment; or a billing system interface.

16. The method of claim 9 comprising the additional step of allowing a user access to the server over a network such that the user may review the utility bill.

17. The method of claim 16 wherein the network is the internet.

18. A method of obtaining a meter reading, comprising the steps of:
connecting a control circuit to the utility meter, the utility meter being at a first location;
transmitting a request to the control circuit to read to utility meter from a second location;
reading the utility meter to obtain the meter reading; and
transmitting the meter reading to desired location over a communications network.

19. The method of claim 18 comprising the additional step of generating a utility bill in response to the meter reading.

20. The method of claim 18 wherein communications network is selected form the group consisting of: wire-line, wireless data service, internet layers using an internet protocol, wireless terminal forward control channel, and wireless terminal reverse control channel.

21. The method of claim 18 comprising the additional steps of:
operatively connecting a telephony device to the control circuit;
operatively connecting the telephony device to the communications network; and
operatively connecting a peripheral device to the telephony device.

22. The method of claim 21 wherein the peripheral device has the ability to transmit and receive data over the communications network using the telephony device and wherein the control circuit controls receipt and transmission of the data by the peripheral device over the communications network using the telephony device.

23. The method of claim 22 wherein the peripheral device is selected from the group consisting of: a conventional telephone; a wireless, broadband device; a second utility meter; a cordless telephone; a security system; an electrical control panel interface; industrial equipment; or a billing system interface.

24. The method of claim 18 comprising the additional step of allowing a user access to the desired location over a second network such that the user may review the utility bill.

25. The method of claim 24 wherein the second network is the internet.
